(19) United States
(12) Patent Application Publication
(10) Pub. No.: US 2013/0151766 A1
(43) Pub. Date: Jun. 13, 2013

(54) CONVERGENCE OF MEMORY AND STORAGE INPUT/OUTPUT IN DIGITAL SYSTEMS

(71) Applicant: Moon J. Kim, Wappingers Falls, NY (US)

(72) Inventor: Moon J. Kim, Wappingers Falls, NY (US)

(21) Appl. No.: 13/316,782

(22) Filed: Dec. 12, 2011

(51) Int. Cl. G06F 12/06

(52) U.S. Cl. 711/105; 711/E12.078

(57) ABSTRACT

Embodiments of the present invention relate to CPU and/or digital memory architecture. Specifically, embodiments of the present invention relate to various approaches for adapting current designs to provide connection of a storage unit to a CPU via a memory unit through the use of controllers. This allows for system data to flow from the CPU to the memory unit to the storage unit. Such a configuration is enabled by the use of an extended memory access scheme that comprises a plurality of row address strobes (RAS) and a column address strobe (CAS) (and, optionally, one or more data bit line DQs).

### CROSS-REFERENCE TO RELATED APPLICATION

This application is related in some aspects to co-pending application Ser. No. 13/295,668, entitled “CENTRAL PROCESSING UNIT (CPU) ARCHITECTURE AND HYBRID MEMORY STORAGE SYSTEM,” filed on Nov. 14, 2011, the entire contents of which are herein incorporated by reference.

### FIELD OF THE INVENTION

The present invention relates generally to memory architecture. Specifically, embodiments of the present invention the convergence of memory and storage input/output (I/O) in digital systems.

### BACKGROUND OF THE INVENTION

As storage devices are used in memory technologies (e.g., flash and DDR devices) in order to speed up data access, conventional storage system designs have not been changed. That is, convention designs still utilize I/O interfaces. As such, conventional designs have storage access imbalances (for example, CPU (0.2 ns), DRAM (30 ns), DRAM SSD (500 ns), Flash SSD (25,000ns), and HDD (10,000,000 ns)). Although, memory system technology has been utilizing DRAM-based approaches, many business applications require even larger memory spaces in order to take advantage of more recent CPU technology advancement.

Heretofore, various approaches have unsuccessfully tried to alleviate these issues.

U.S. Pat. No. 6,581,137 discloses a data storage system that utilizes an interface between a set of disk drives and a host computer. The interface includes a central processing unit main memory consisting of an SDRAM and an RDRAM.

U.S. Pat. No. 6,065,097 discloses a computer system with an internal memory controller that interfaces between the CPU, external cache, and primary memory “through a single unified memory bus.”

U.S. Pat. No. 5,564,015 discloses a computer system that utilizes a “CPU activity monitor”. This monitor receives mode signals from the CPU, cache miss signals from a cache memory system, and a clock signal. Improved CPU monitoring is the intention of this invention with the potential to reduce power consumption of the computer system based upon the monitoring.

U.S. Pat. No. 4,476,526 discloses a buffered cache memory subsystem. Solid-state cache memory is interfaced to a microprocessor memory storage director. The microprocessor memory storage director interfaces with control modules for “controlling operation of a long-term data storage device such as a disk drive.” In one embodiment, memory data is saved in the cache memory option when it is “expected to be the subject of a future host request” and is intended to improve operational efficiency.

U.S. Pat. No. 4,460,959 discloses a logic control system that utilizes cache memory and a “transfer control logic unit” that manages the transmission of “procedural information” and CPU instructions. The logic control system uses a common communication bus between the CPU and I/O controllers and memory units.

U.S. Pat. No. 7,861,040 discloses a cache control memory apparatus that includes cache memory in the volatile and nonvolatile memory modules.

U.S. Pat. No. 7,581,064 discloses a method using cache data to optimize access of cache memory. Software is utilized to analyze memory utilization. This analysis is used to optimize memory access.

U.S. Pat. No. 6,836,816 discloses method for utilizing flash memory as a low-latency cache device that is “on an integrated circuit”. The patent claims to “improve average access times between a processor and the main memory.” The cache is designed to interface with the process using a standard bus negating the need for a redesigned memory bus that would otherwise be necessary.

U.S. Pat. No. 6,591,340 discloses an improved memory management unit that includes the use of virtual cache memory and “a translation lookaside buffer”. The method relies on permission rights for memory data access.

U.S. Pat. No. 6,567,889 discloses a modified storage controller with cache memory. In one embodiment, a “virtual solid state disk storage device is a single virtual disk drive for storing controller based information”. Redundancy of the storage controller is achieved with a “standard battery backup and redundant controller features of RAID controller technology”.

U.S. Pat. No. 5,802,560 discloses a computer system apparatus that uses a memory chip with multiple SRAM caches linked to a single DRAM memory block. The design uses separate memory buses between the combined memory devices and the CPU or PCI controller.

U.S. Patent Application 20110202707 discloses a hybrid storage device comprised of SSD memory, disc-type memory, and a “hybrid data storage device controller” that is in communication with both memory devices and a NVMHCI controller.

### SUMMARY OF THE INVENTION

In general, embodiments of the present invention relate to CPU and/or digital memory architecture. Specifically, embodiments of the present invention relate to various approaches for adapting current designs to provide connection of a storage unit to a CPU via a memory unit through the use of controllers. This allows for system data to flow from the CPU to the memory unit to the storage unit. Such a configuration is enabled by the use of an extended memory access scheme that comprises a plurality of row address strobes (RAS) and a column address strobe (CAS) (and, optionally, one or more memory data lines). In one embodiment, a memory unit is coupled to a first controller and a second controller. The first controller is coupled to a DRAM interface, such as synchronous double data rate (DDR), while the second controller is coupled to a set (one or more) of storage units. Thus, under the embodiments of the present invention, access to storage is provided via dynamic random access memory (DRAM) (e.g., without an I/O hub). Moreover, the memory unit may be accessed by the storage unit via a storage mapper, while storage space is accessed by the memory unit via virtualization.

A first aspect of the present invention, a memory architecture, comprising: a central processing unit (CPU); a memory controller coupled to the CPU; a memory unit coupled to the memory controller; a storage controller coupled to the memory unit; and a storage unit coupled to the storage controller, wherein system data flows from the CPU to the memory unit via the memory controller, and wherein the system data flows from the memory unit to the storage unit via the storage controller.

A second aspect of the present invention provides a memory architecture, comprising: a memory unit; a first controller coupled to the memory unit; a double data rate (DDR) interface coupled to the first controller; a second controller coupled to the memory unit; and a set of storage units coupled to the second controller.

A third aspect of the present invention provides a method for forming a memory architecture, comprising: coupling a memory controller to a central processing unit (CPU); coupling a memory unit to the memory controller; coupling a storage controller to the memory unit; and coupling a storage unit to the storage controller, wherein system data flows from the CPU to the memory unit via the memory controller, and wherein the system data flows from the memory unit to the storage unit via the storage controller.

A fourth aspect of the present invention provides a memory architecture, comprising: a first memory unit; a first controller coupled to the memory unit; a synchronous dynamic random access memory (SDRAM) interface coupled to the first controller; a second controller coupled to the memory unit; a second memory unit coupled to the second controller; a third controller coupled to the second memory unit; and a set of storage units coupled to the second controller.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a general purpose computing system.

FIG. 2A depicts a conventional CPU/memory design.

FIG. 2B depicts a CPU/memory design according to an embodiment of the present invention.

FIG. 2C depicts another CPU/memory design according to an embodiment of the present invention.

FIG. 3A depicts a conventional system data flow.

FIG. 3B depicts a system data flow according to an embodiment of the present invention.

FIG. 4A depicts a conventional CPU/memory design.

FIG. 4B depicts a CPU/memory design according to an embodiment of the present invention.

FIG. 4C depicts another CPU/memory design according to an embodiment of the present invention.

FIG. 5A depicts another CPU/memory design according to an embodiment of the present invention.

FIG. 5B depicts another CPU/memory design according to an embodiment of the present invention.

FIG. 6A depicts a conventional CPU/memory design.

FIG. 6B depicts a CPU/memory design according to an embodiment of the present invention.

FIG. 6C depicts another CPU/memory design according to an embodiment of the present invention.

FIG. 7A depicts a conventional addressing scheme.

FIG. 7B depicts an addressing scheme according to an embodiment of the present invention.

FIG. 7C depicts another addressing scheme according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In general, embodiments of the present invention relate to CPU and/or digital memory architecture. Specifically, embodiments of the present invention relate to various approaches for adapting current designs to provide connection of a storage unit to a CPU via a memory unit through the use of controllers. This allows for system data to flow from the CPU to the memory unit to the storage unit. Such a configuration is enabled by the use of an extended memory access scheme that comprises a plurality of row address strobes (RAS) and a column address strobe (CAS) (and, optionally, one or more DQs). In one embodiment, a memory unit is coupled to a first controller and a second controller. The first controller is coupled to a double data rate (DDR) interface, while the second controller is coupled to a set (one or more) of storage units. Thus, under the embodiments of the present invention, access to storage is provided via dynamic random access memory (DRAM) (e.g., without an I/O hub). Moreover, the memory unit may be accessed by the storage unit via a storage mapper, while storage space is accessed by the memory unit via virtualization.

In a typical embodiment of the present invention, memory space is extended beyond physical space though virtualization. It is connected to storage space using a memory translator. Storage space is extended to memory space to enhance speed. As such, the storage space is connected to memory through a storage mapper and/or memory-to-storage mapper. Hereunder, memory can be an off-CPU cache of storage. The storage should be fast enough to support memory operation and storage can be accessed directly

Still yet, memory space is extended using an additional description tag stored in a specified register and memory location. Along these lines, unwired memory address space pins, pre-existing memory address pins, and/or general purpose I/O pins can be used to extend the address space. In another embodiment, memory space and associated threads are virtualized within the limited memory space. Specifically, a thread sees physical address space, while the operating system (OS) maintains virtualization of threads. This allows, among other things, for total address space which is practically infinite

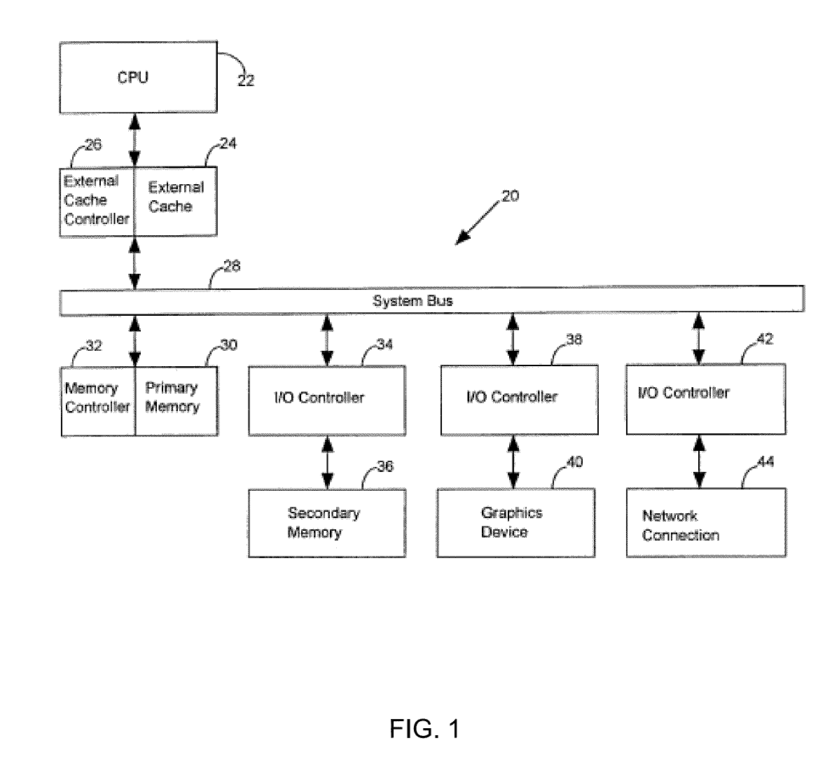

FIG. 1 is an illustration of a general purpose computer 20. The computer 20 includes a central processing unit (CPU) 22. The CPU 22 executes instructions of a computer program. Each instruction is located at a memory address. Similarly, the data associated with an instruction is located at a memory address. The CPU 22 accesses a specified memory address to fetch the instruction or data stored there.

Most CPUs include an on-board memory called a cache. The cache stores a set of memory addresses and the instructions or data associated with the memory addresses. If a specified address is not in the internal, or L1 cache, then the CPU 22 looks for the specified address in an external cache, also called and L2 cache 24. The external cache is typically implemented using Static Random Access Memories (SRAMs). Standard SRAMs are simply storage devices. Thus, they are operated with a separate circuit known as an external cache controller 26.

If the address is not in the external cache 24 (a cache miss), then the external cache 24 requests access to a system bus 28. When the system bus 28 becomes available, the external cache 24 is allowed to route its address request to the primary memory 30. The primary memory 30 is typically implemented using Dynamic Random Access Memories (DRAMs). As in the case of SRAMs, DRAMs are simply memory devices. Thus, they are operated with a separate circuit known as an external memory controller 32.

The data output from the primary memory 30 is applied to the system bus 28. It is then stored in the external cache 24 and is passed to the CPU 22 for processing. The processing described in reference to FIG. 1 must be performed for every address request. Indeed, if the address request is not found in the primary memory 30, similar processing is performed by an input/output controller 34 associated with a secondary memory 36.

As shown in FIG. 1, there are additional devices connected to the system bus 28. For example, FIG. 1 illustrates an input/output controller 38 operating as an interface between a graphics device 40 and the system bus 28. In addition, the figure illustrates an input/output controller 42 operating as an interface between a network connection circuit 44 and the system bus 28.

The multiple connections to the system bus 28 result in a relatively large amount of traffic. It would be desirable to remove memory transactions from the system bus 28 in order to reduce traffic on the system bus 28. It is known to remove memory transactions from the system bus 28 by using a separate memory bus for external cache 24 and a separate memory bus for primary memory 30. This approach results in a relatively large number of CPU package pins. It is important to reduce the number of CPU package pins. Thus, it would be highly desirable to reduce the traffic on the system bus without increasing the number of CPU package pins. In addition, it would be desirable to eliminate the need for the external logic associated with external cache and primary memories.

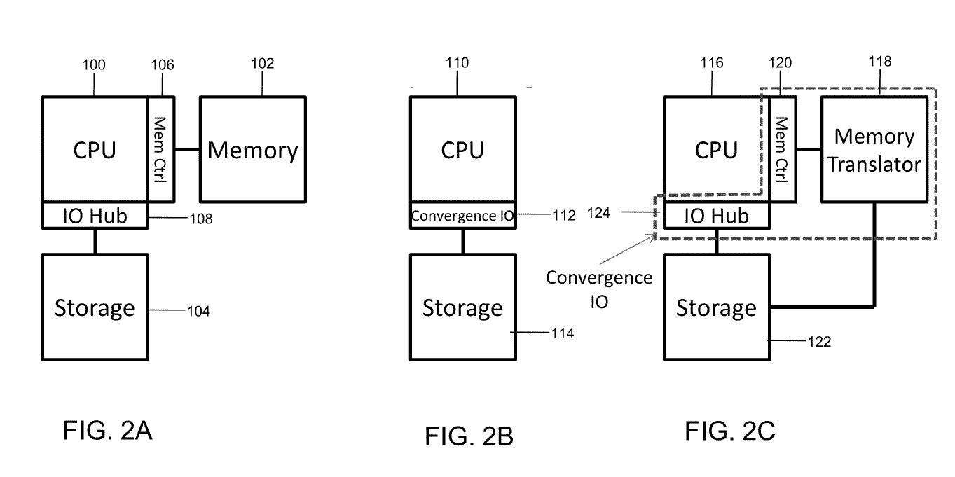

Referring now to FIG. 2A, a conventional CPU/memory architecture is shown. As depicted, CPU 100 is coupled to storage unit 104 via I/O hub 108 and to memory unit 102 via memory controller 106. This conventional design can be very inefficient and slow. FIG. 2B shows a CPU/memory architecture according to one embodiment of the present invention. As depicted, CPU 110 is coupled to storage unit 114 via convergence I/O 112. Thus, memory unit 102 can be removed from the system and CPU 110's memory request can be directly handled by the storage unit 114. In another embodiment shown in FIG. 2C, a memory translator 118 can be coupled to CPU 116 via memory controller 120 while storage unit 122 remains coupled to CPU 116 via I/O hub 124. In this latter embodiment, memory translator 118 can be used to map the CPU 116's memory request to storage block.

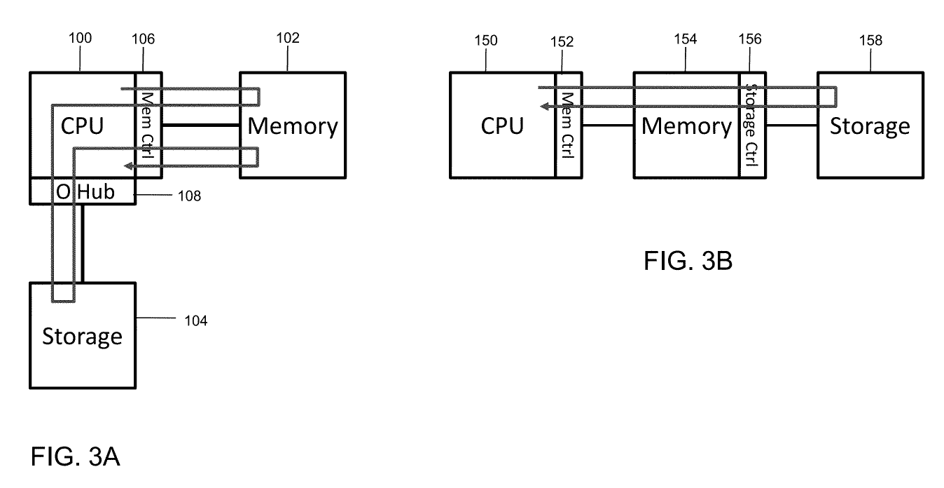

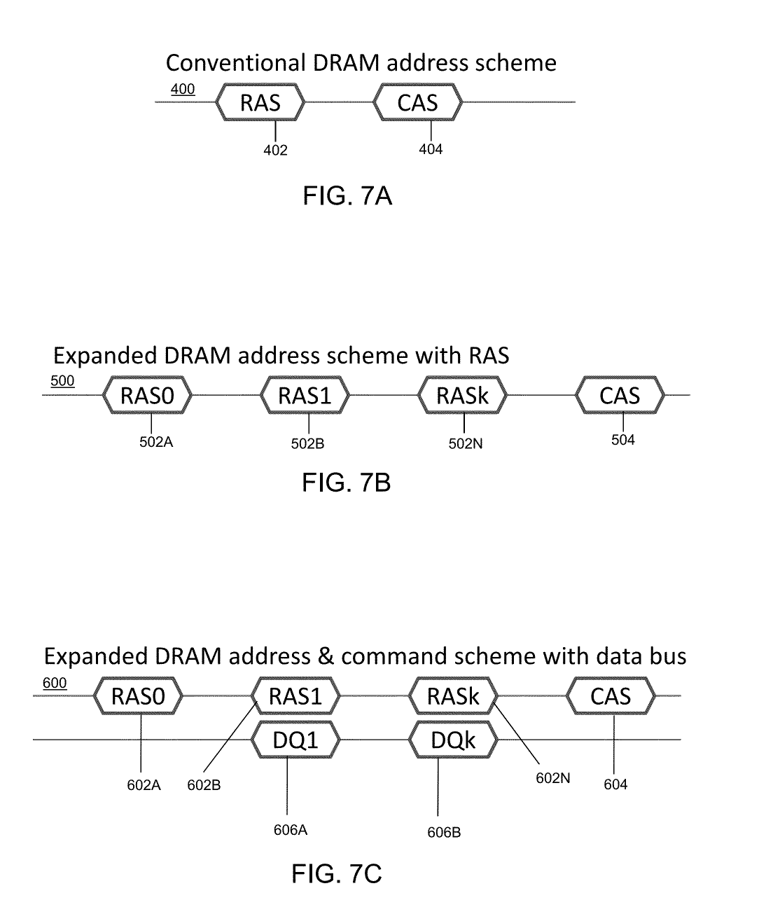

Referring now to FIG. 3A, data flow through a conventional CPU/memory architecture is shown. As depicted, CPU 100 is coupled to storage unit 104 via I/O hub 108 and to memory unit 102 via memory controller 106. As further depicted, system data flows in multiple individual data flows. One system data flow is between between CPU 100 and memory 102, while a second is between CPU 100 and storage 104. This flow configuration can be very inefficient and slow. FIG. 3B shows a CPU/memory architecture according to one embodiment of the present invention. As shown, CPU 150 is coupled to memory unit 154 via memory controller 152, while memory unit 154 is coupled to storage unit 158 via storage controller 156. This configuration allows a single data flow through the system. Specifically, system data flows from CPU 150 to memory unit 154 to storage unit 158. In this embodiment, storage unit 158 is traversed via an extended memory address scheme that will be further shown and described in conjunction with FIG. 7.

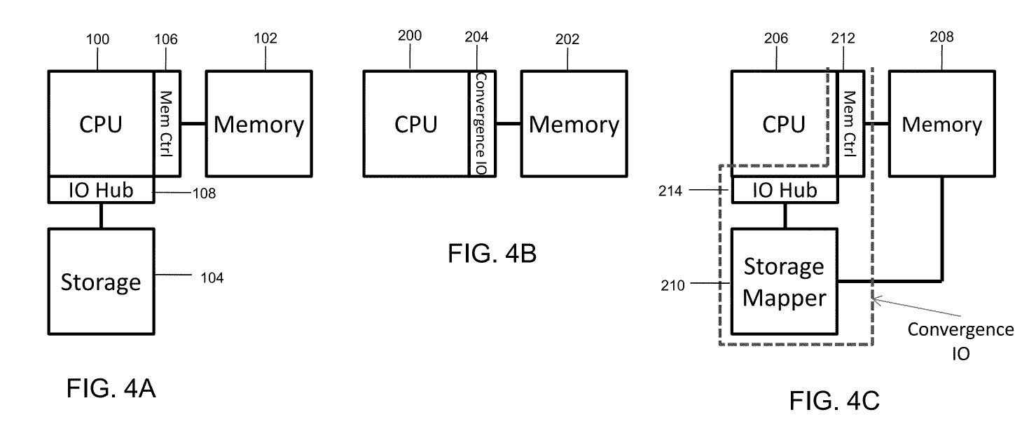

FIGS. 4A-C show an additional set of architectures. Referring now to FIG. 4A, the conventional CPU/memory architecture is shown again. As depicted, CPU 100 is coupled to storage unit 104 via I/O hub 108 and to memory unit 102 via memory controller 106. As mentioned, this conventional design can be very inefficient and slow. FIG. 4B shows a CPU/memory architecture according to another embodiment of the present invention. As depicted, CPU 200 is coupled to memory unit 202 via convergence I/O 204. Thus, storage units 114 and 122 shown in FIGS. 2B-C can be removed from the system and CPU 200 memory request can be directly handled by memory unit 202. In another embodiment shown in FIG. 4C, a storage mapper 210 can be coupled to CPU 206 via I/O hub 214 while memory unit 208 remains coupled to CPU 206 via memory controller 212. In this latter embodiment, storage mapper 210 can be used to map the CPU 206's storage request to memory block 208.

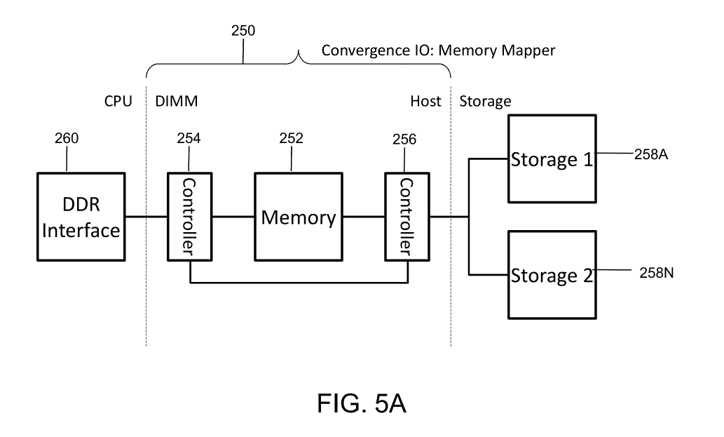

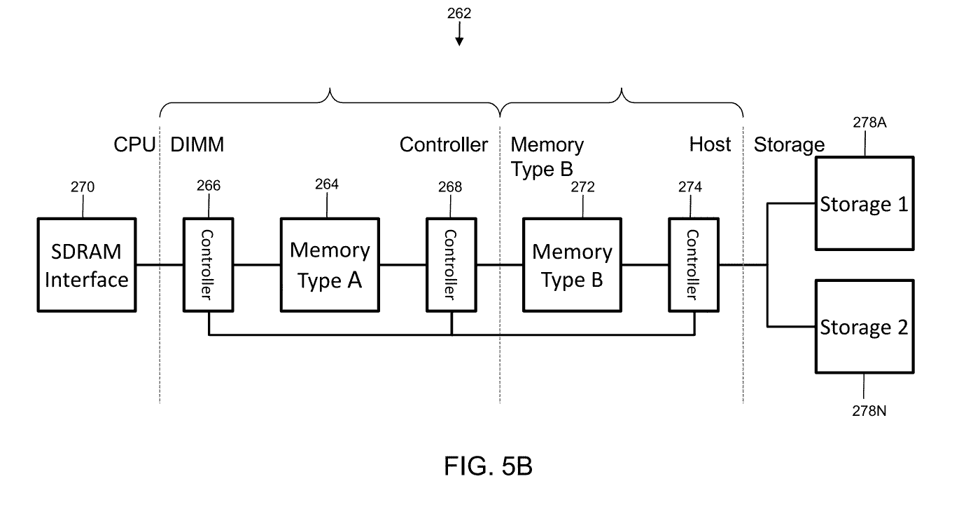

Referring now to FIG. 5A, an architecture according to an embodiment of the present invention is depicted. Specifically, in FIG. 5A, a convergence I/O (e.g., memory mapper) 250 is shown. As depicted, memory unit 252 is coupled to CPU-side controller 254 and to storage-side controller 256. Controller 254 is coupled to double data rate (DDR) interface 260, while controller 256 is coupled to a set (e.g., at least one) of storage units 258A-N. Under this embodiment, DIMM interface 260 replaces conventional I/O unit(s). Also, controller 254 emulates DIMM I/O to memory unit 252, while controller 256 maps storage devices 258A-N to memory space/unit 252. A DRAM interface and address space (not shown) are expanded to cover the entire storage space. Further, memory unit 252 can function as at least one of the following: cache memory (partially), DIMM memory (partially), and/or a storage mirror (partially).

Referring now to FIG. 5B (I don't see FIG. 5B in the ppt file), a multiple memory architecture 262 according to another embodiment of the present invention is shown. As depicted, architecture 262 comprises memory unit (type “A”) 264 coupled to controllers 266 and 268. Controller 266 is coupled to a synchronous dynamic random access memory (SDRAM) unit 270, while controller 268 is coupled to memory unit (type “B”) 272. Memory unit 272 is coupled to controller 274, which is coupled to set of storage units 278A-N. In this embodiment, multiple memory units having varying types can be utilized. It is understood that in the embodiments of FIGS. 5A-B, a single system data flow convention may be implemented similar to FIG. 3B

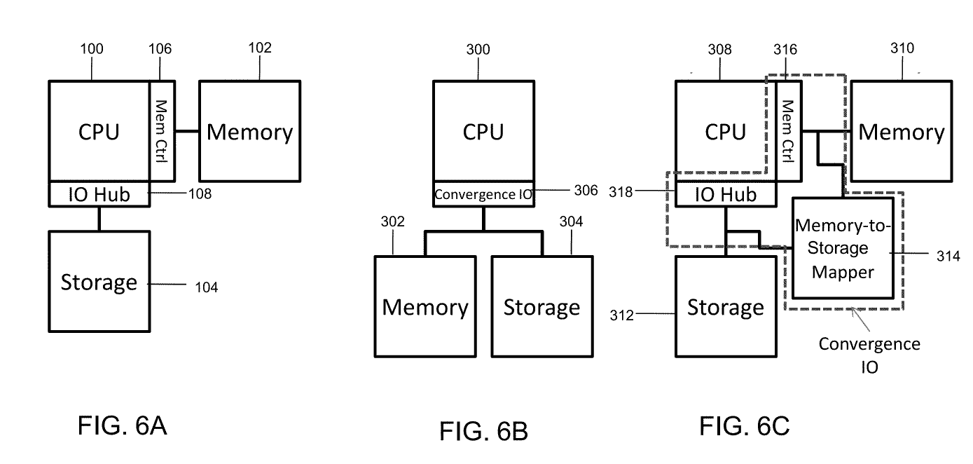

FIGS. 6A-C show a similar set of architectures. Referring now to FIG. 6A, the conventional CPU/memory architecture is shown again. As depicted, CPU 100 is coupled to storage unit 104 via I/O hub 108 and to memory unit 102 via memory controller 106. As mentioned, this conventional design can be very inefficient and slow. FIG. 6B shows a CPU/memory architecture according to another embodiment of the present invention. As depicted, CPU 300 is coupled to memory unit 302 and storage unit 304 via convergence I/O 306. In another embodiment shown in FIG. 6C, a memory-to-storage mapper 314 can be coupled to CPU 308 via a convergence I/O 306, memory unit 310 is coupled to CPU 308 via memory controller 316, and storage unit 312 is coupled to CPU 308 via I/O hub 318.

Referring now to FIG. 7A, a conventional DRAM address scheme 400 is shown. As depicted, a single row address strobe (RAS) unit 402 and a single column address strobe (CAS) unit 404 are utilized. However, under the embodiments of the present invention, this type of scheme may be extended and/or enhanced. For example, FIG. 7B shows an extended address scheme 500 according to one embodiment of the present invention. As depicted, scheme 500 may comprise multiple RAS units 502A-N as well as one or more CAS units 504 (a single CAS unit is shown for illustrative purposes only). In another embodiment shown in FIG. 7C, an extended address scheme 600 can be provided that may comprise RAS units 602A-N, one or more CAS units 604 as well as data bit line DQ units 606A-B. In the embodiments shown in FIGS. 7B-C, modification and expansion of the SDRAM address scheme to yield schemes 500 and/or 600 allows infinite address space extension, additional command mode, status register space, etc.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A memory architecture, comprising:
a central processing unit (CPU);
a memory controller coupled to the CPU;
a memory unit coupled to the memory controller;
a storage controller coupled to the memory unit; and
a storage unit coupled to the storage controller, wherein system data flows from the CPU to the memory unit via the memory controller, and wherein the system data flows from the memory unit to the storage unit via the storage controller.

2. The memory architecture of claim 1, wherein the storage unit is traversable via an extended address scheme in the memory unit

3. The memory architecture of claim 2, wherein the extended address scheme comprises a dynamic random access memory (DRAM) address scheme.

4. The memory architecture of claim 2, wherein the extended address scheme comprises:
a plurality of row address strobe (RAS) units; and
at least one column address strobe unit coupled to the plurality of RAS units.

5. The memory architecture of claim 4, wherein the extended address scheme further comprises a plurality of dataline DQ units.

6. The memory architecture of claim 2, the extended address scheme being provided at least one of the following:
a set of unwired memory address space pins; or
a set of pre-existing memory address space pins; or
a set of I/O pins.

7. The memory architecture of claim 1, wherein the memory unit is accessed by the storage unit via a storage mapper.

8. The memory architecture of claim 1, wherein the storage unit is accessed by the memory unit via virtualization.

9. The memory architecture of claim 1, wherein the memory architecture lacks an I/O hub.

10. A memory architecture, comprising:
a memory unit;
a first controller coupled to the memory unit;
a double data rate (DDR) interface coupled to the first controller;
a second controller coupled to the memory unit; and
a set of storage units coupled to the second controller.

11. The memory architecture of claim 10, the first controller being configured to emulate dual inline memory module (DIMM) I/O to the memory unit.

12. The memory architecture of claim 10, the second controller mapping the set of storage units to the memory unit.

13. The memory architecture of claim 10, the memory unit functioning as at least one of the following: cache memory, DIMM memory, or storage mirror-type memory.

14. A method for forming a memory architecture, comprising:
coupling a memory controller coupled to a central processing unit (CPU);
coupling a memory unit to the memory controller;
coupling a storage controller to the memory unit; and
coupling a storage unit to the storage controller, wherein system data flows from the CPU to the memory unit via the memory controller, and wherein the system data flows from the memory unit to the storage unit via the storage controller.

15. The method of claim 14, wherein the storage unit is traversable via an extended address scheme in the memory unit

16. The method of claim 15, wherein the extended address scheme comprises a dynamic random access memory (DRAM) address scheme.

17. The method of claim 15, wherein the extended address scheme comprises:
a plurality of row address strobe (RAS) units; and
at least one column address strobe unit coupled to the plurality of RAS units.

18. The method of claim 17, wherein the extended address scheme further comprises a plurality of data bit line DQ units.

19. The method of claim 15, the extended address scheme being provided at least one least one of the following:
a set of unwired memory address space pins; or
a set of pre-existing memory address space pins; or
a set of I/O pins.

20. The method of claim 15, wherein the memory unit is accessed by the storage unit via a storage mapper, and wherein the storage unit is accessed by the memory unit via virtualization.

21. A memory architecture, comprising:
a first memory unit;
a first controller coupled to the memory unit;
a synchronous dynamic random access memory (SDRAM) interface coupled to the first controller;
a second controller coupled to the memory unit;
a second memory unit coupled to the second controller;
a third controller coupled to the second memory unit; and
a set of storage units coupled to the second controller.
